(19) United States
(12) Patent Application Publication
(10) Pub. No.: US 2012/0300394 A1
(43) Pub. Date: Nov. 29, 2012

(54) PROTECTIVE CASE FOR TABLET COMPUTER

(76) Inventor: Brian K. NORFOLK, Everett, WA (US)

(21) Appl. No.: 13/117,712

(22) Filed: May 27, 2011

(51) Int. Cl. G06F 1/16; B65B 1/04; B65D 85/30

(52) U.S. Cl. 361/679.55; 206/320; 53/473

(57) ABSTRACT

A protective tablet computer case for the burgeoning tablet computer market. The protective case has a cradle and a shock absorbing perimeter bumper. The cradle includes a base, a shallow side wall, and an inwardly projecting flexible lip. They form a cavity of a size to hold a tablet computer. The perimeter bumper includes graspable handles. In one form of the invention, the protective case is generally rectangular in shape with one graspable handle per side. The entire protective case may be injection molded from soft EVA foam. Air gaps may be added between the graspable handles and the cradle. The invention is lightweight, flexible, yet strong and can be readily adapted for school, office, home, laboratory, or construction environments.

### TECHNICAL FIELD

The present invention relates generally to protective cases for tablet computers. More particularly, the invention generally relates to protective cases having bumpers that can also function as handles.

### BACKGROUND OF THE INVENTION

Tablet computers have come into vogue with launch of the Apple iPad. The iPad and various competitive products have a flat display screen, a thin generally uniform body with outer edges, and (depending on the model) generally instant connectivity to the Internet and Web browsers. Such tablet computers generally do not include a lot of software, but rather software applications (or informally “apps”) that are run on software as a service (SAAS) as part of “cloud computing.”

These types of tablet computers have become wildly popular with the public as increasing number of downloadable apps provided by SAAS providers are available and accessible via the Internet. Such tablet computers are much less costly than desktop computers or conventional laptop computers, require little expensive software, are extremely portable, easily connect to the Internet and Web browsers, and are easy to use. But they are still costly enough, e.g., many hundreds of dollars, that protection from dropping/rough handling is desired.

Because tablet computers are easy to use, have touch access, as well as audio and visual outputs, they are quickly being adopted by schools for young students. Young students can easily drop a thin and fragile tablet computer and also need a way to grab the tablet computer without touching the tablet computer directly. Further, older users would desire a strong, but preferably lightweight, protective case that can cushion the tablet computer's thin edges if dropped and provides an easy carry case for traveling/moving about. Thus, a protective case with bumpers that also function as a grip or handle would be desired.

### SUMMARY OF THE INVENTION

The present invention is directed to a protective case configured to encase a tablet computer having a generally planar front and corresponding back with a uniform thin edge between the front and back. The case includes a base having a shallow sidewall and an inwardly directed lip. The sidewall forms a perimeter about the base. The perimeter sidewall and lip and base form a cavity of a size to securely hold the tablet computer of the type described above. The perimeter lip is comprised of a flexible material. The base conforms to the shape of the back of the tablet computer while the shallow sidewall and lip is of a size and shape to conform about the thin edge of the tablet computer.

The protective case further includes an external bumper that generally frames the base and perimeter sidewall. The bumper is at least partially comprised of a shock absorbing material and is of a shape that can be grabbed by a human hand.

According to one embodiment of the present invention, the protective case is substantially rectilinear in shape where the base and perimeter sidewall form a substantially rectilinear shape and each side of the combined base and sidewall corresponds to its own external shock absorbing bumper. The base and external bumper frame may be generally rectilinear in shape with the bumpers framing the interior base, sidewall and lip.

In another embodiment of the invention, there is an air gap between each bumper and its corresponding side of the combined base and sidewall. In preferred form this air gap is of a size and shape to allow human fingers to more readily grip about the bumpers and function as traditional handles. The air gap may itself be substantially rectilinear in shape.

To insert the tablet computer into the protective case, a portion of the lip is pulled away to slide the tablet computer into the cavity. The perimeter lip resumes its shape over the front of tablet computer and securely holds the tablet computer within the combined base and sidewall so that there is minimal to no movement of the tablet computer relative to the protective case. The inwardly projecting lip covers a small perimeter portion of the front of the tablet computer such that nearly the entire front of the tablet computer is visible.

Another embodiment may include a transparent cover that is configured to correspond to the front of the tablet computer. During insertion, the cover is positioned into the cavity after the tablet computer is inserted or the cover is placed atop of the front of the tablet computer and inserted into the cavity of the protective case at the same time. Similar to the embodiment without the transparent cover, the inwardly projecting lip covers a small perimeter portion of the cover such that nearly the entire front of the tablet computer is visible through the transparent cover.

These and other advantages will become more apparent upon review of the Drawings, the Detailed Description of the Invention, and the Claims.

### BRIEF DESCRIPTION OF THE DRAWINGS

Like reference numerals are used to designate like parts throughout the several views of the drawings, wherein:

FIG. 1 is front perspective view of a protective case of the present invention illustrating a cradle having a base, side wall and inwardly projecting lip that is configured to cradle a tablet computer and a perimeter bumper having graspable handles;

FIG. 2 is top plan view of FIG. 1;

FIG. 3 is back view of FIG. 1;

FIG. 4 is a bottom plan view of FIG. 1;

FIG. 5 is a right side elevation view of FIG. 1;

FIG. 6 is a left side elevation view of FIG. 1;

FIG. 7 is a section view taken substantially across lines 7-7 of FIG. 1;

FIG. 8 is a front perspective view illustrating the insertion of a tablet computer into a cradle of the protective case;

FIG. 9 is a view like that of FIG. 8 except with the tablet computer fully inserted and cradled by the protective case;

FIG. 10 is a back view of FIG. 9 except with a portion of the base illustrated in cutaway to expose the back of the tablet computer;

FIG. 11 is a front view illustrating a first alternate embodiment of the present invention illustrating an air gap between the cradle and graspable handles;

FIG. 12 is a rear perspective view illustrating the alternate embodiment of FIG. 11 and as well as an alternate cradle where the base has cut outs to lighten up the overall weight of the protective case;

FIG. 13 is a section view taken substantially along lines 13-13 of FIG. 12 and illustrating an alternate graspable handle shape;

FIG. 14 is a view like that of FIG. 13 except illustrating yet another graspable handle shape;

FIG. 15 is a view like FIG. 13 except illustrating yet another graspable handle shape, along with the insertion of the tablet computer and an optional transparent cover over the tablet computer display screen; and

FIG. 16 is a front view of a work station containing a multitude of tablet computers encased in the protective cover of the present invention.

### DETAILED DESCRIPTION OF THE INVENTION

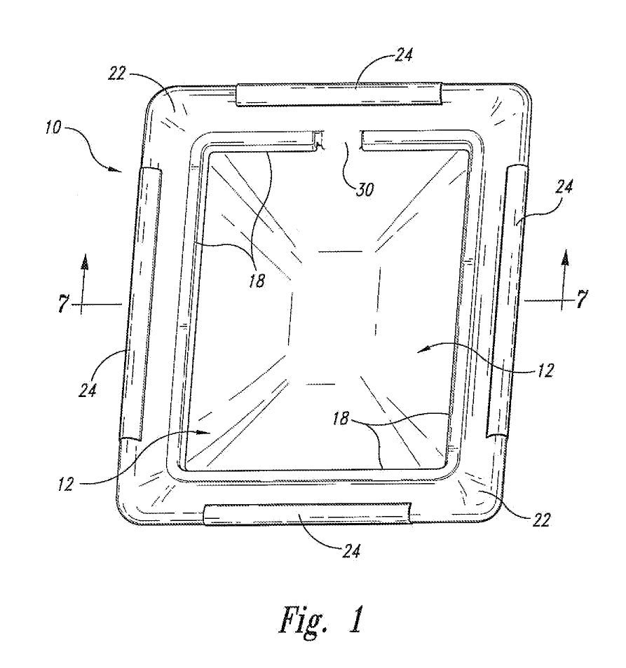

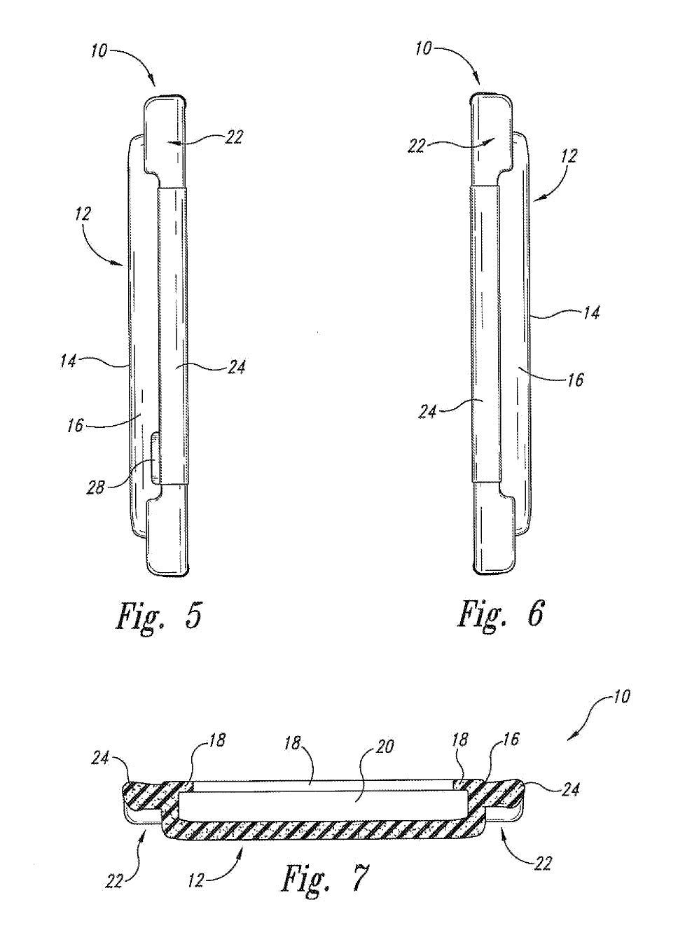

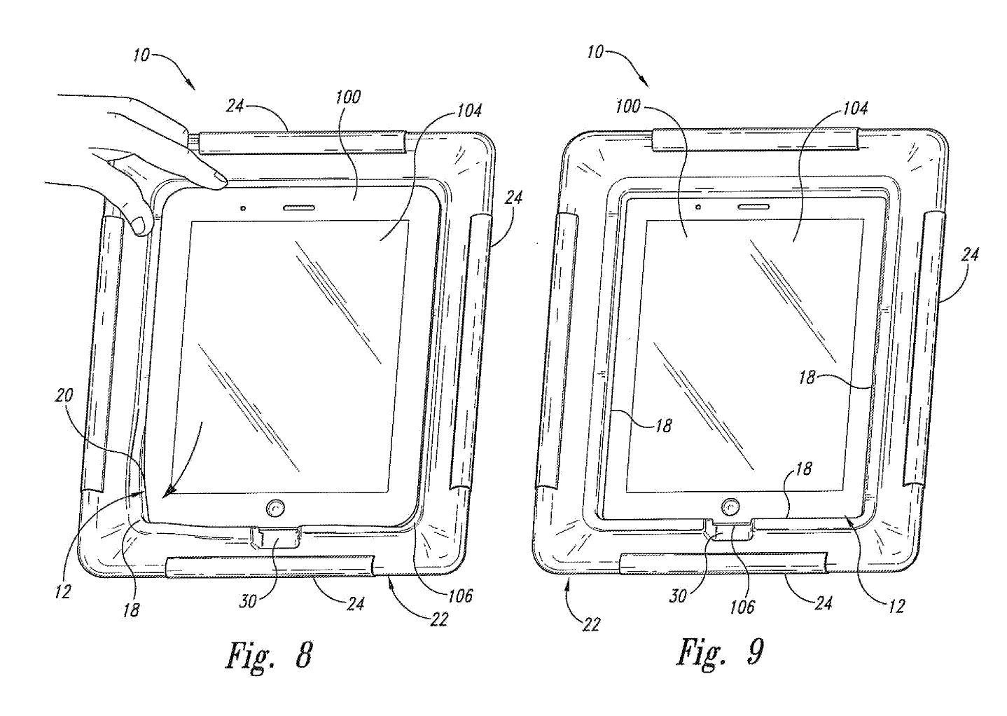

The present invention is directed to a protective tablet computer case that has bumpers about its periphery that can also be used as handles. Referring to FIGS. 1-10, a protective tablet computer case 10 is illustrated in various views. Protective case 10 includes a cradle 12 of a size and shape to hold a thin tablet computer 100 (illustrated in FIGS. 8-10) such as an Apple iPad having a generally planar back 102, a generally planar front 104, and a thin perimeter side wall 106 connecting the back 102 to the front 104. Cradle 12 includes a base 14, a shallow side wall 16 where one end of the shallow side wall is adjoined to the base, and an inwardly projecting lip 18 that is adjoined to the other end of the shallow base. The resulting base 14, shallow side wall 16, and inwardly projecting lip form a cavity 20 that can closely conform to the shape of tablet computer 100.

A shock absorbing bumper 22 forms a protective perimeter about the cradle. At least a portion of the perimeter bumper 22 includes a graspable handle 24.

According to one aspect of the invention, the cradle is generally configured in a rectangular shape. The perimeter bumper 22 also is configured in a substantially rectangular shape to form sides 26. Each side 26 may have its own graspable handle 24. As illustrated in FIGS. 1-10, there are four graspable handles 24.

The protective case may be made from a shock absorbing material, such as an injection molded EVA foam or other soft and flexible foam or man-made material that is flexible, shock absorbing, and, preferably can resume a shape after mild deformation. It is envisioned that the entire protective case could be injection molded from a unitary mold. At least the lip 18 of the cradle is made of a flexible, resilient, material that is deformable when an external force is applied to it and able to return to its original shape shortly after the external force is removed from the lip. In use, the lip, or at least a portion of the lip, is capable of being moved outwardly and upwardly when an external force is applied to it, such as a hand or the edge of a tablet computer pushed against the lip.

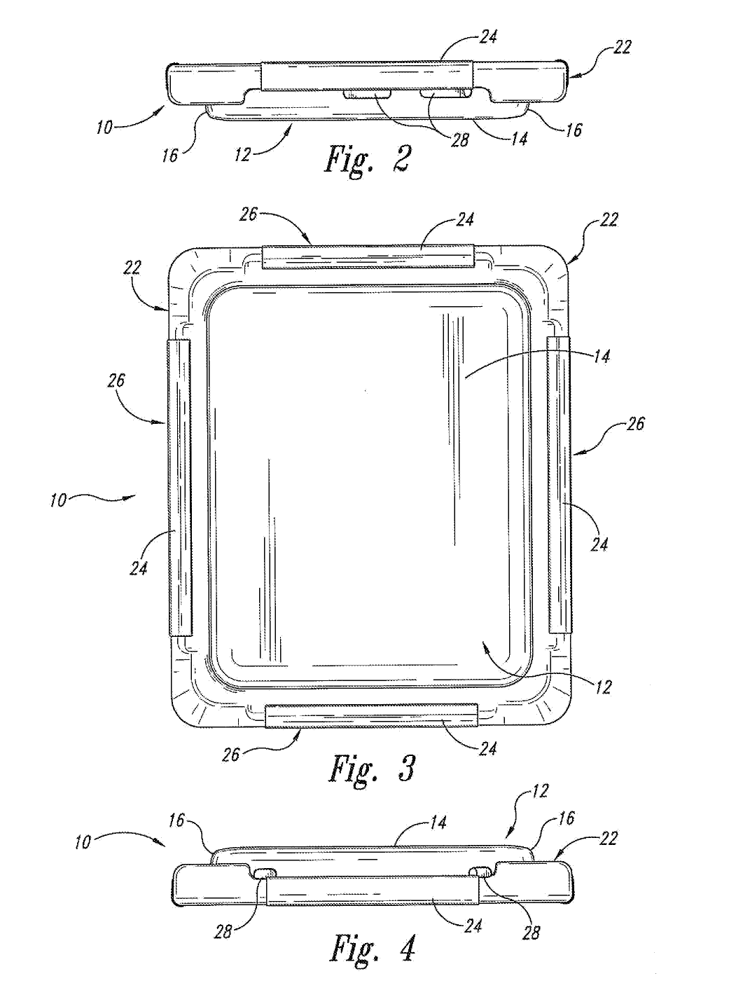

Ports 28, such as visible in FIGS. 2, 4, and 5, may be formed within cradle side wall 16 to allow easier access to corresponding inputs on the tablet computer 100. An additional opening 30 (see FIG. 1) may also be formed from the cradle side wall 16 and lip 18 to better access key tablet computer functional access points.

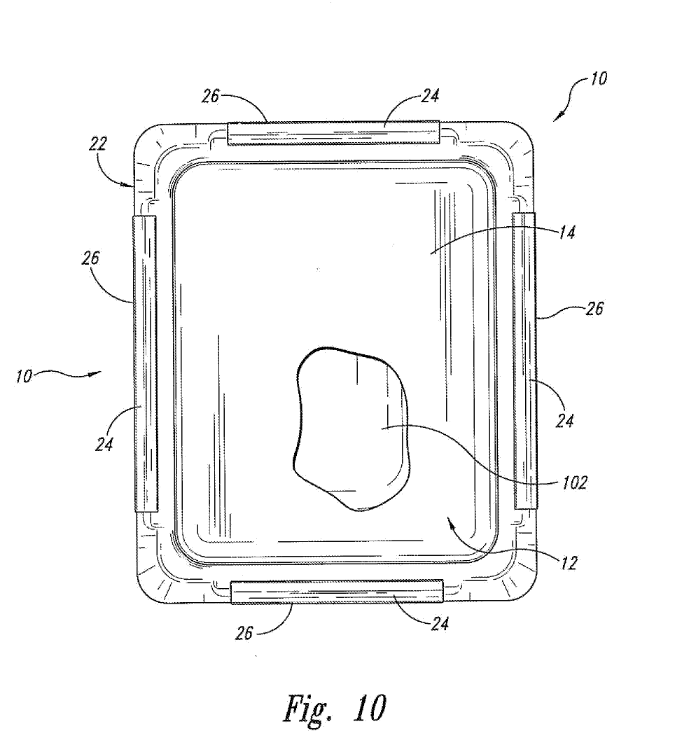

Referring particularly to FIGS. 8-10, the tablet computer 100 is inserted into and encased by the protective case 10 by applying a force unto the lip to move outwardly to allow the cradle lip and side wall sufficient deformation to fit the tablet computer 100 into the cradle cavity 20. The back 102 of the tablet computer 100 rests atop of the base 14 (FIG. 10) and the cradle side wall 16 closely confronts the thin side wall 106 of the tablet computer 100. Once the tablet computer is fully inserted into the cradle cavity 20, the cradle lip 18 covers a small portion of the tablet computer front 104 periphery as illustrated in FIG. 9.

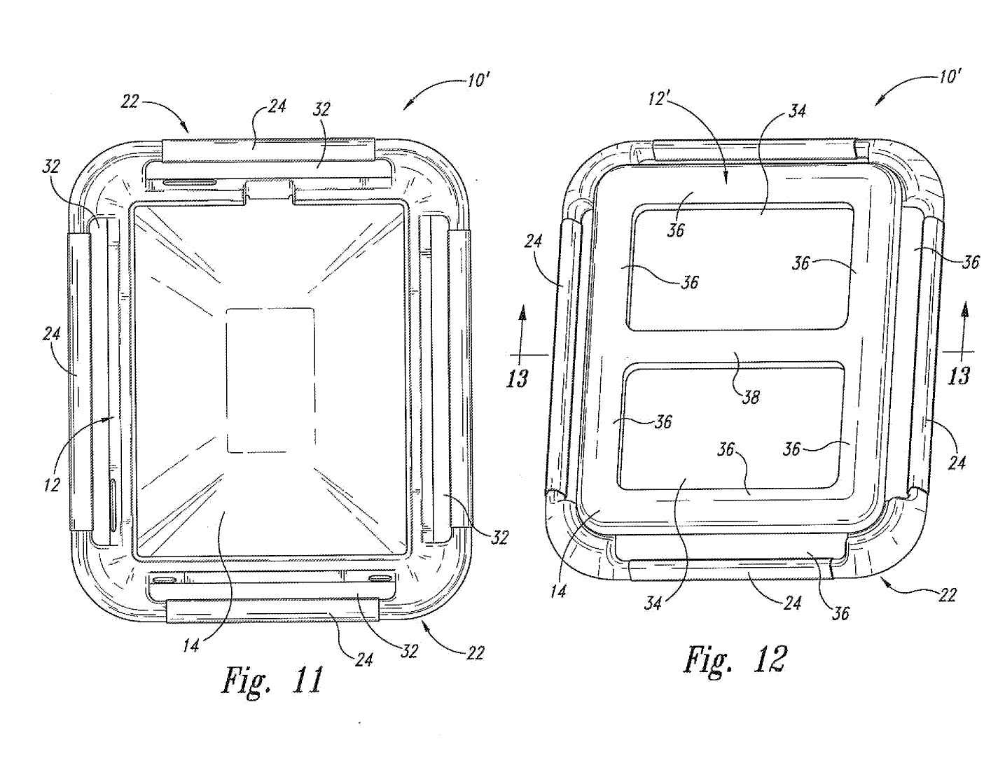

Referring now to FIGS. 11-15, alternate embodiments are illustrated. FIG. 11 and FIG. 12 both illustrate an alternate protective case 10′ in which air gaps 32 are formed between the cradle 12 and the graspable handles 24 for easier access to the handles. The air gaps may be rectangular in shape to conform to the overall rectilinear shape of the tablet computer, the cradle, and the perimeter bumper. The air gaps also frees up weight to the overall protective case when holding or moving the tablet computer in the normal course of tablet computer usage or for travel.

Additional weight may be removed from the cradle base 14 by adding cut outs 34 as illustrated in FIG. 12. The new cradle base 12′ still includes sufficient structural support for the tablet computer (perimeter coverage 36 and a lateral bracing 38 are examples illustrated in FIG. 12 of how this may be accomplished). Many designs can accomplish this function, e.g., removing weight from the back, yet still retaining the tablet computer within the cradle cavity, such as plurality of small squares or circles placed about the back or a general “X” shape. The myriad of varying shapes are envisioned as part of the present invention.

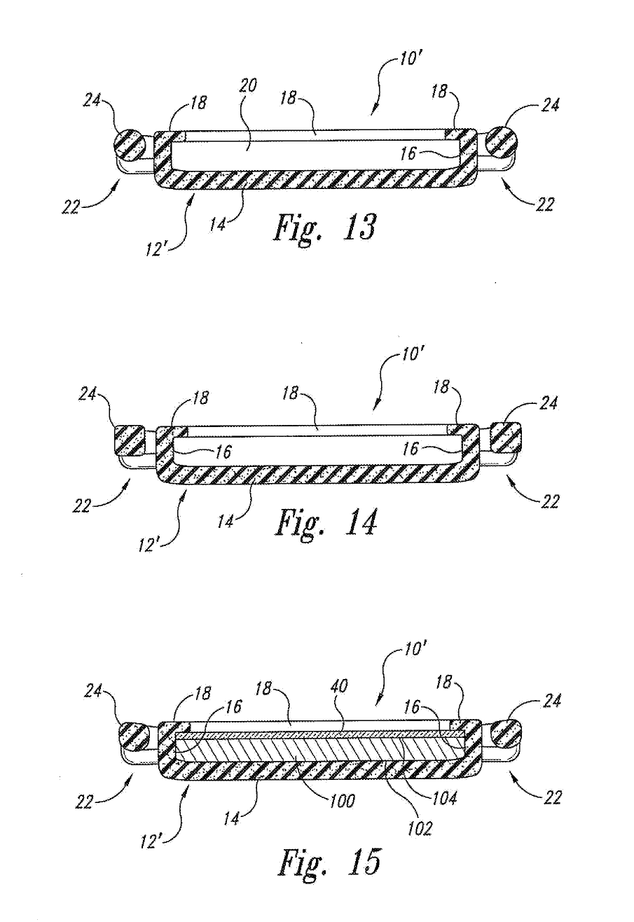

Referring now to FIGS. 13-15, as well as previously discussed FIG. 7, the handle itself can have many varying cross sectional shapes. For example, the handle in section view may have a shape like a triangle (FIG. 7), a circle (FIG. 13), a square (FIG. 14), or something in between (FIG. 15). Further, the handles do not even need to be uniform through the handle length. Additional padding, such as foam, may cover the handle for better graspability.

Another option feature is illustrated in FIG. 15 where the protective case may further include a protective transparent cover 40 to provide extra protection to the tablet computer screen. The transparent cover 40 rests atop of the tablet computer front 104, both of which are inserted into the cradle cavity. The cradle lip 18 covers a perimeter portion of the transparent cover.

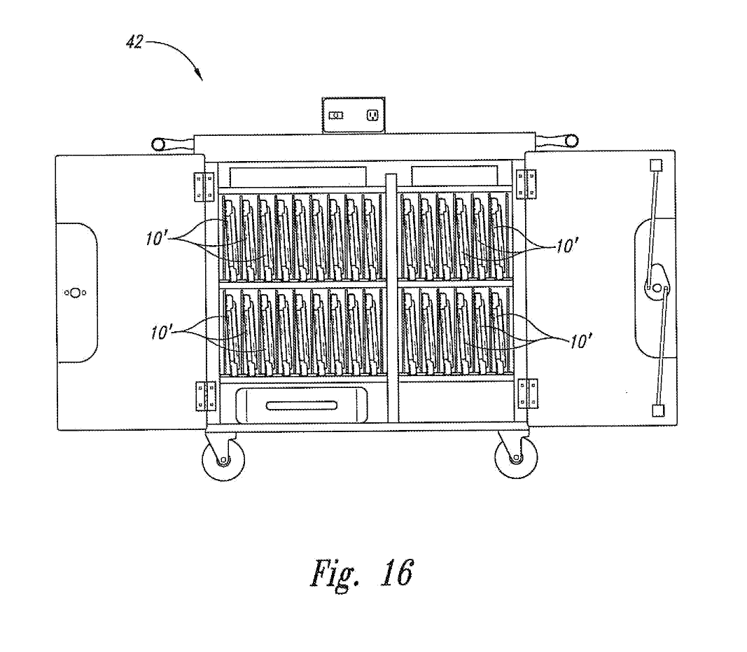

Referring to FIG. 16, the protective case is ideal for primary and secondary schools where the school buys its own tablet computers and stores/charges a large number of tablet computers in the a lockable work station 42. Each tablet computer may be cradled into its own protective case of the present invention and stored/docked/charged within the work station. In this way, young children can quickly grab and grasp a tablet computer by the handles of the perimeter bumper from the work station for an educational learning session yet protect the expensive tablet computer from unintentional breakage due to dropping or banging into another object.

Because the protective case is preferably made from a lightweight, yet sturdy, molded foam product, color can be readily added for identification for team activities (e.g., the red protective covers could be assigned a topic for study, such as geography games, while another team having blue protective covers could be working on math problems) or divided by class room identification or lab room.

Advantages of the present invention include providing a lightweight all in one protective case for a tablet computer that has handles and protects the tablet computer from damage if dropped or banged into other objects.

The illustrated embodiments are only examples of the present invention and, therefore, are non-limitive. It is to be understood that many changes in the particular structure, materials, and features of the invention may be made without departing from the spirit and scope of the invention. Therefore, it is the Applicant's intention that his patent rights not be limited by the particular embodiments illustrated and described herein, but rather by the following claims interpreted according to accepted doctrines of claim interpretation, including the Doctrine of Equivalents and Reversal of Parts.

What is claimed is:

1. A protective tablet computer case comprising:
a cradle comprising a base, a shallow side wall defined by a lower edge portion and an upper edge portion, the lower edge portion being connected to the cradle base; and an inwardly projecting and flexible lip; said lip being connected to the upper edge portion of the side wall; wherein said base, side wall, and lip form a cavity configured to cradle a tablet computer; and
a shock absorbing perimeter bumper that extends about the cradle wherein portions of said bumper are graspable handles.

2. The protective tablet computer case according to claim 1 further comprising air gaps between the perimeter bumper and the graspable handles.

3. The protective tablet computer case according to claim 1 wherein the cradle and perimeter bumper is generally rectangular in shape having four sides.

4. The protective tablet computer case according to claim 1 wherein the protective case is made from injection molded EVA foam.

5. The protective tablet computer according to claim 4 wherein color may be added to the injection molded EVA foam.

6. The protective tablet computer case according to claim 1 wherein the base includes at least one cut out.

7. The protective tablet computer case according to claim 1 further comprising a transparent cover that is configured to fit within the cradle cavity atop of the tablet computer but below the lip.

8. The protective tablet computer case according to claim 3 wherein each side of the perimeter bumper includes a graspable handle.

9. The protective tablet computer case according to claim 8 further comprising air gaps between the perimeter bumper and the graspable handles.

10. The protective tablet computer case according to claim 1 further comprising ports within the cradle to correspond to ports on the tablet computer.

11. A combination of a tablet computer and a protective cover; said combination comprising:
a tablet computer having a planar front and a planar back with a thin side wall connecting the tablet computer front to the tablet computer back;
a protective case having a cradle and a shock absorbing perimeter bumper;
said cradle having a base, a shallow side wall, and an inwardly projecting lip, together defining a cavity of a size and shape to cradle the tablet computer where the tablet computer back makes contact with the cradle base, the tablet computer front is positioned within the cradle and a perimeter of the tablet computer front closely held within the cradle cavity by the cradle lip; and
said perimeter bumper extending about the cradle and wherein portions of said bumper are graspable handles.

12. The combination according to claim 11 wherein the protective case is made from an injection molded EVA foam.

13. The combination according to claim 11 further comprising air gaps between the graspable handles of the perimeter bumper and the cradle.

14. A method of inserting a tablet computer into a protective case; said method comprising:
providing a tablet computer having a planar front and a planar back with a thin side wall connecting the tablet computer front to the tablet computer back;
providing a protective case having a cradle and a shock absorbing perimeter bumper, wherein said cradle has a base, a shallow side wall, and an inwardly projecting, flexible lip, together defining a cavity of a size a shape to cradle the tablet computer;
exerting a force on the flexible lip to pull at least a portion of the lip away from the cavity;
inserting the tablet computer into the cavity via a side wall of the tablet computer;
positioning the tablet computer into the cavity wherein the tablet computer back makes contact with the cradle base, the tablet computer sidewall is cradled by the side wall of the cradle;
removing the force from the flexible lip to allow the lip to resume its original shape and to have the lip cover a periphery of the tablet computer front.

15. A combination of a work station with a plurality of protected tablet computers; said combination including:
a work station container that can accommodate a plurality of tablet computers for storage and charging;
a plurality of protected tablet computers, each said tablet computer having a planar front and a planar back with a thin side wall connecting the tablet computer front to the tablet computer back; and wherein each said tablet computer is cradled into a protective case;
each said protective cases having a cradle and a shock absorbing perimeter bumper; wherein the cradle has a base, a shallow side wall, and an inwardly projecting lip, together defining a cavity of a size and shape to cradle the tablet computer and wherein the tablet computer back makes contact with the cradle base, and wherein the tablet computer front is positioned within the cradle and a perimeter of the tablet computer front closely held within the cradle cavity by the cradle lip; and wherein each said perimeter bumper extends about the cradle and further wherein portions of each said bumper are graspable handles.

16. The combination of claim 15 wherein the plurality of protective cases are comprised of two or more colors.

17. The combination of claim 15 wherein the plurality of protective cases is made from an injection molded EVA foam.
